(19) United States
(12) Patent Application Publication
(10) Pub. No.: US 2010/0328934 A1
(43) Pub. Date: Dec. 30, 2010

(54) Self-Powered Luminant Banner

(76) Inventor: Kuei-Sheng Tsou, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/490,323

(22) Filed: Jun. 24, 2009

(51) Int. Cl. F21L 13/00

(52) U.S. Cl. 362/192

(57) ABSTRACT

A self-powered luminant banner is provided, including at least a brace, at least a blade, and a controller. The blade is attached to the brace with at least one side. The blade further includes at least an embedded piezoelectric transducer and at least a luminous element attached to the blade. The piezoelectric transducer embedded in the blade has related circuitry for electrically connecting to the controller so that the controller can power the luminous element and control the luminance of luminous element or store the excessive power. When the banner of the present invention is deformed or vibrates due to the airflow, the embedded transducer will transforms the mechanical energy into electrical energy to power the luminous element. In comparison with the conventional banner that requires extra lights connected to a power cable, the self-powered luminant banner of the present invention is both convenient to use and cost-effective, as well as provides safer application.

### FIELD OF THE INVENTION

The present invention generally relates to a luminant banner, and more specifically to a self-powered luminant banner.

### BACKGROUND OF THE INVENTION

Banners, flags, pennants and other similar hanging elements are a popular decoration and sign element for many outdoor activities, events and advertisements. However, most banners require extra lighting to illuminate after dark to remain visible and effective. As power cable for outdoor power supply is usually cumbersome, may pose potential danger of being tripped over and is subject to wet/harsh weather conditions, the idea of using power cable to illuminate outdoor banners is sometimes abandoned after evaluating the cost and the potential safety issues. Therefore, many outdoor banners lost their decorative, identification or advertisement purpose without illumination after dark.

On the other hand, various alternative renewable energies have been explored in the last decades, such as, solar power, tidal power, wind energy, and so on. For example, lamp pole with solar battery is a popular new addition to street lighting in many cities. However, due to the power efficiency and the cost considerations, most solar-powered lamp poles usually include extra power system, such as, electricity grid. Another example of street light with wind power is the wind-based electricity-generation using the windmill to transform the wind energy into the rotational dynamics, and then using a generator module to transform the mechanical energy into electrical energy. This type of generator has a better capacity. However, the disadvantages include the low efficiency, large size, complex structure and high manufacturing cost.

U.S. patent application Ser. No. 12/346,880 disclosed an aerodynamic vibration power-generation device, by embedding plural transducers made of piezoelectric material, such as Lead Zirconate-titanate (PZT), BaTiO₃, quartz, ZnO, or other special chemical compounds (PVDF), in a blade so that when the blade vibrates or deforms due to the wind, the mechanical energy can be transformed into electrical energy, so-called Piezoelectric Effect.

It is therefore imperative to devise an outdoor luminant banner by applying the aerodynamic vibration power-generation device to overcome the aforementioned disadvantages of conventional outdoor banners.

### SUMMARY OF THE INVENTION

The primary object of the present invention is to provide a self-powered luminant banner, having at least a piezoelectric transducer embedded inside a blade with at least a luminous element. The blade is an aerodynamic vibration element that has the capability of airflow spoiling and fluttering when the airflow impacts or passes along the surfaces of the blade. The deformation and the vibration of the blade will also cause the embedded piezoelectric transducer to deform and vibrate to generate electric charge, which is then used to power the luminous element attached to the blade so that the banner is luminous-able without extra power supply.

To achieve the above object, the present invention provides a self-powered luminant banner, including at least a brace, at least a blade, and a controller. The blade is attached to the brace with at least one side. The blade further includes at least an embedded piezoelectric transducer and at least a luminous element attached to the blade. The piezoelectric transducer embedded in the blade has related circuitry for electrically connecting to a controller to provide power and control the luminous element. When the banner of the present invention is deformed or vibrates due to the airflow, the embedded transducer will transforms the mechanical energy into electrical energy to power the luminous element. In comparison with the conventional banner that requires extra luminaries connected to power cable, the self-powered luminant banner of the present invention is both convenient to use and cost-effective, as well as provides safer application.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of an embodiment of a self-power luminant banner according to the present invention.

### DETAILED DESCRIPTION OF THE PREFERRED EMBODIMENTS

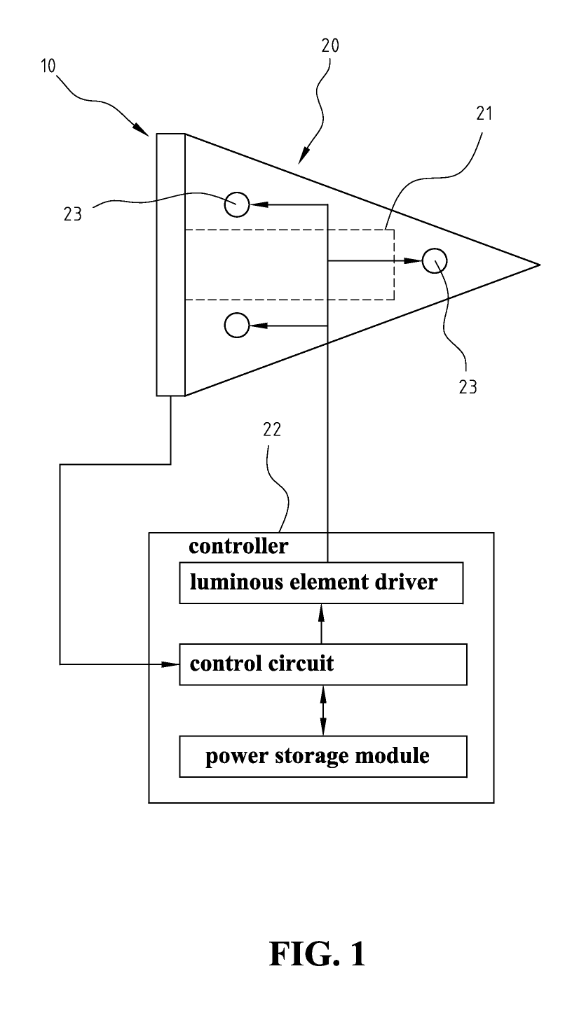

FIG. 1 shows a schematic view of the first embodiment of the present invention. As shown in FIG. 1, a self-powered luminant banner 100 of the present invention includes a brace 10, a blade 20, and a controller 22. One side of blade 20 is attached to brace 10. Blade 20 is a thin and flexible aerodynamic vibration element further includes at least an embedded piezoelectric transducer 21 with related circuit connecting to controller 22, and at least a luminous element 23. It is worth noting that the shape of blade 20, the number and the placement of transducers 21 and the number and the placement of luminous elements 23 on blade 20 are not restricted to any specific setting. The embodiment shown in FIG. 1 is of illustrative, not restrictive, purpose. For example, the embodiment shown in FIG. 1 includes a piezoelectric transducer 21 and three luminous elements 23, and the shape of blade 20 is triangular.

Piezoelectric transducer 21 is made of piezoelectric material and electrodes, and is deflectable and flexible. When piezoelectric transducer 21 is vibrated because of the vibration of blade 20, piezoelectric transducer 21 will transform the mechanical energy of vibrating blade 20 into electrical energy and output electric current. Piezoelectric transducer 21 also has related circuitry to connect to controller 22. Controller 22 is for controlling the electricity generated by transducer 21 to power luminous elements 23. Controller 22 further includes a control circuit, a power storage module and a luminous element driver, where the control circuit is connected respectively to the luminous element driver for powering the luminous elements 23 and controlling the luminance of luminous elements 23 and the power storage module for storing excessive power generated by piezoelectric transducer 21. Luminous elements 23 are not limited to any specific type, and can be any luminary attached to blade 20. For example, luminous elements 23 can be LED, OLED, or other low-power consumption lighting elements. The various lighting modes of luminous elements 23, under the control of controller 22, may include continuous lighting, blinking, flickering, color changing, luminance changing, and so on, for various objectives.

Luminous elements can be either attached to the surface of blade 20 or embedded inside blade 20 with the mechanism for the light to shine through, such as, blade 20 is made of transparent material, or lens on the surfaces of blade 20 to emit the light from luminous elements 23.

When the self-powered luminant banner of the present invention is used, the airflow causes blade 20 vibrated or deformed, which further causes embedded transducer 21 to generate electrical charges. The electrical charges is fed to controller 22 for further processing into a sufficient and stable electrical current to power luminous elements 23 and control the luminance of luminous elements 23 of blade 20. The power storage module can store excessive power when luminous elements 23 are switched off or the airflow is strong or changes rapidly so that embedded transducer 21 generate more electrical charges than consumed by luminous elements 23. The power stored in the power storage module can then be used to power luminous elements 23 and control the luminance of luminous elements 23 by control circuit when there is no airflow or the airflow is insufficient to generate power consumed luminous elements 23. As shown, the banner of the present invention is self-contained and no extra lighting, power supply and related power cable are required to illuminate the banner of the present invention. In comparison to the conventional banner, the present invention is easy to use and cost-effective, while provides a safer application that is usually associated with messy power lines and wet or harsh weather conditions.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A self-powered luminant banner, comprising:
at least a brace;
at least a blade, with at least one side attached to said brace, further comprising:
at least a piezoelectric transducer embedded inside said blade; and
at least a luminous element; and
a controller, electrically connected to both said embedded piezoelectric transducer and said luminous element of said blade using related circuitry;
wherein airflow causing said blade vibrating or deforming, and resulting in said embedded transducer to generate electrical charges converted into electrical power by said controller for powering and controlling said luminous element.

2. The self-powered luminant banner as claimed in claim 1, wherein said controller further comprises:
a control circuit;
a luminous element driver, connected to said control circuit and said luminous element for powering said luminous element and controlling luminance of said luminous element; and
a power storage module, connected to said control circuit for storing excessive power generated by said piezoelectric transducer and supplying power when generated power by said piezoelectric transducer being insufficient.

3. The self-powered luminant banner as claimed in claim 1, wherein said controller further controls various display modes of said luminous element.

4. The self-powered luminant banner as claimed in claim 1, wherein said luminous element is attached to surface of said blade.

5. The self-powered luminant banner as claimed in claim 1, wherein said luminous element is embedded inside said blade having mechanism for light emitting from said luminous element to shine through.

6. The self-powered luminant banner as claimed in claim 5, wherein said mechanism is lens attached to said blade.
